(19) United States
(12) Patent Application Publication
(10) Pub. No.: US 2003/0208541 A1
(43) Pub. Date: Nov. 6, 2003

(54) Handheld wireless conferencing technology

(76) Inventor: Jeff Musa, Plano, TX (US)

Correspondence Address: Robert C. Klinger, Jackson Walker LLP, Suite 600, 2435 North Central Expressway, Richardson, TX, 75080, US

(21) Appl. No.: 10/288,005

(22) Filed: Nov. 5, 2002

Related U.S. Application Data
(60) Provisional application No. 60/337,404, filed on Nov. 10, 2001.

(51) Int. Cl. G06F 15/16

(52) U.S. Cl. 709/205; 709/237

(57) ABSTRACT

A system, method, and software architecture/program (10) for handheld PDA (110) applications and users of handheld applications to implement real time wireless collaboration conferencing with a physically remote communication device. Advantageously, the program (10) provides for wireless collaboration conferencing without significant changes to the handheld applications. The handheld application updates its internal state to mirror that of the other participant's devices. The wireless collaboration software implements wireless collaboration conferencing methods which are optimized for the data communication bandwidth, uses native handheld applications fitted to their performance and metrics of a handheld device, communicates using small packets of information, provides a common programmable and user interface for peer-to-peer, peer-to-multi-peer, and peer-to-machine application conferencing, and which software enables end users to schedule, share, manage, and be billed for such conference activity.

### FIELD OF THE INVENTION

The invention relates generally to wireless conferencing, and more particularly, in a handheld computer configured as a wireless method for information exchange, a system, software program and method for exchanging, processing, and referencing information between two or more users simultaneously in real or near real-time through a wireless platform.

### BACKGROUND OF THE INVENTION

Conferencing systems are by now fairly commonplace mechanisms for allowing multiple people in different locations to collaborate and work together on one or more topics. Telecommnunications companies and other vendors offer voice-based teleconferencing over traditional phone lines. Video conferencing is in use as well, although due to video equipment expense and bandwidth limitations it has not reached the mainstream as quickly as once anticipated. Computer-based conferencing has existed for a number of years, in forms such as Symantec's pcAnywhere and Microsoft's NetMeeting, allowing PC users to collaborate over a shared software application or file. Finally, web collaboration conferencing has become available, allowing application and content collaboration to be performed over standard web protocols and Internet connections.

Collaboration conferencing is the ability to exchange synchronous communication between two or more participants. The communication media can be any enabled software application such as word processor, spreadsheet, or presentation. Multiple participants in the conference can communicate through the media such as presenting a set of slides. Each participant would see slides at the same time. The next level of communication allows the participants to make changes that are replicated on all of the participant computers. An example would be a participants working on a spreadsheet.

Several companies have developed wireline collaboration conferencing that includes both voice and data. Collaboration conferencing has excluded mobile handheld participants for three or more reasons: bandwidth constraints because desktop conferencing protocols typically rely on screen sharing more than true application sharing, screen size because the desktop metaphor doesn't fit a typical handhelds 2×3 inch screen, and wired collaboration communication methods which rely upon fast networks and optimal switching to synchronize the conference.

Bandwidth constraints are due the wide area network infrastructure limitations. There are multiple competing standards for wireless wide area network data transfer. The current maximum widely available bandwidth varies between 9800-19200 bits per second. Higher speed technologies such as those grouped under the moniker 3G have been under development for some time but are not widely available and are just now becoming available in limited areas. Further, most proposed 3G systems provide optimal and saturated bandwidth maximum and minimum transfer rates such that for years to come wireless bandwidth will be capacity constrained.

Screen size constraints are due to the form factor of the mobile handheld computer. These devices typically have a screen of approximately two inches by two to four inches. Any information displayed on mobile handheld computers should be formatted to fit the small screen size.

Wired collaboration communication methods are built to allow participants a view of the shared information. The applications are not actually running on the participants' computers. Indeed, the participants are looking at a “view” of the application running on the host machine. The information is not stored locally on each participant's computer. When a screen is changed such as going to the next slide in a presentation, the participant is sent a view of the next slide. This type of collaboration requires significant bandwidth, reliable connections, and complex switching.

What is needed is a system and method, and software architecture/program for handheld applications to implement collaboration conferencing while enforcing the constraints of the wireless handheld computer. Further, a software program and interface which enables applications to leverage the handhelds operating system for more than screen display/sharing, provide rich functionality which is useful prior, during, and after the conference, do so under using a limited amount of bandwidth or bits over the air, and provide a common way to develop such collaboration enabled applications. This enables the ability to interact with one or more users or machines wirelessly using handheld applications. The present invention provides such a system, software program, and method.

### SUMMARY OF THE INVENTION

The present invention achieves technical advantages by providing a system, method, and software architecture/program for handheld applications and users of handheld applications to implement wireless collaboration conferencing while enforcing the constraints of the wireless handheld computer and providing a set of services, and without significant changes to the applications themselves.

The software program, architecture and interface enables off-the-shelf applications to leverage the handheld's operating system for data processing and display both on and offline, and provides rich functionality which is useful prior, during, and after the conference, doing so under using a limited amount of bandwidth or bits over the air, and provides a common way to develop such collaboration enabled applications.

This system implements wireless collaboration conferencing methods which is optimized for the data communication bandwidth, uses native handheld applications fitted to the performance and metrics of a handheld, communicates using small packets of information, provides a common programmable- and user interface for peer-to-peer, peer-to-multi-peer, and peer-to-machine application conferencing, and a system with which end users can schedule, share, manage, and be billed for such conference activity.

This architecture enables two distinct and interrelated modes of conferencing. In one mode, all users have equal rights to modify the document and do so in a collaborative way. The handheld devices received Data Edit Messages which afford each handheld program which implements the invention the ability to update their internal state and data structures to mirror that which is on each of the other participant's devices. In another mode, only the “presenter’ whom has been granted presentation rights from all the participants, controls Display Update Messages that enable each participant's handheld device to be controlled by a single presenter. In this mode, handheld devices all mirror the behavior, screen location, scrolling, and display of the presenter. In both cases, the invention provides a clear mechanism to control and enable and coordinate these states.

### BRIEF DESCRIPTION OF THE DRAWINGS

FIG. 1 is a block diagram of the various wireless collaboration conferences that can be established in near realtime by a PDA and a physically remote communication device enabled with software according to the present invention;

FIG. 2 is a block diagram of a wireless collaboration conference protocol session seen to include a PDA exchanging system messages, data edit messages, and display update messages with a physically remote communication device, such as a PDA and desktop computer;

FIG. 3 is a block diagram of a PDA establishing a connection or waiting for such connection from another device;

FIG. 4 is a block diagram of the CCP event manager receiving messages in the form of a structured set of bits; and

FIG. 5 is a block diagram of DEM and DUM messages being exchanged in a wireless collaborative session.

### DETAILED DESCRIPTION OF THE PREFERRED EMBODIMENT

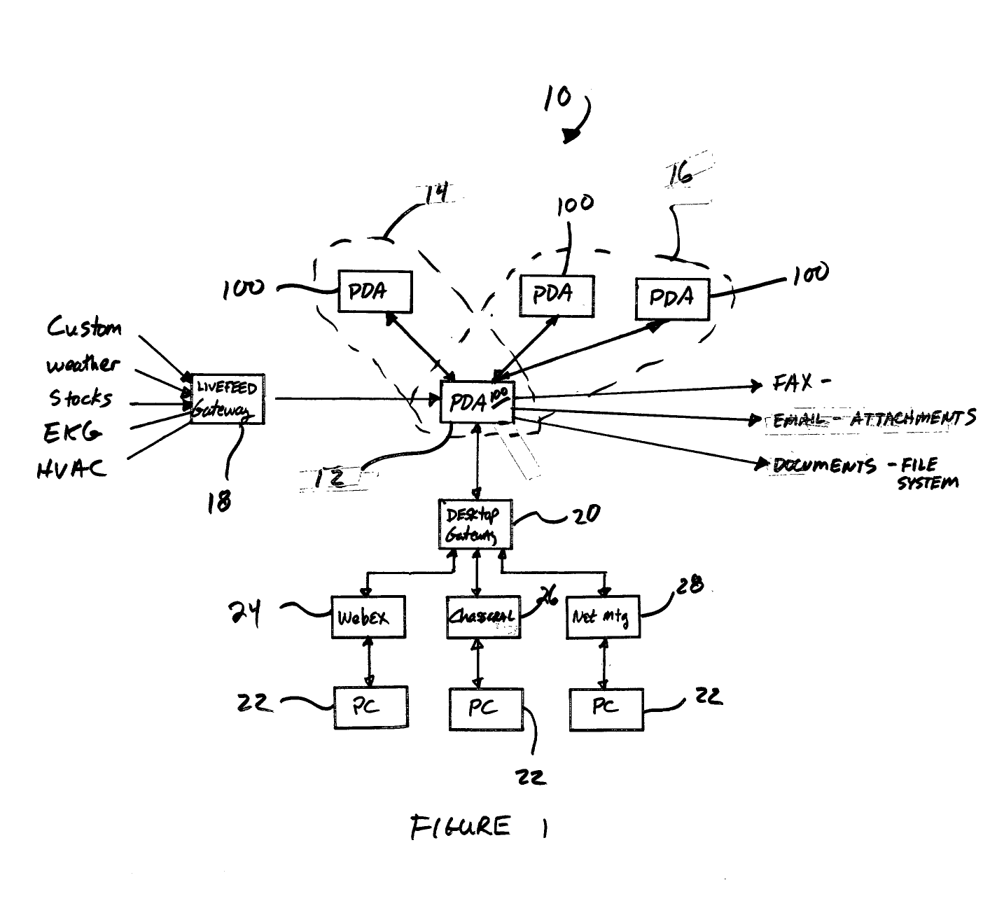

Referring now to FIG. 1 there is depicted at 10 a block diagram of several wireless collaboration conferencing scenarios enabled by the present invention in a wireless environment. This system implements wireless collaboration conferencing methods which is optimized for the data communication bandwidth, uses native handheld applications fitted to the performance and metrics of a handheld, communicates using small packets of information, provides a common programmable- and user interface for peer-to-peer, peer-to-multi-peer, and peer-to-machine application conferencing, and a system with which end users can schedule, share, manage, and be billed for such conference activity.

A first embodiment of the present invention configured as an Application Programming Interface (API) enables multiple independent software vendors (ISVs) to utilize such interface to wirelessly conference enable their applications. The common programmatic interface, common user interface, common events and internal mechanism/architecture enables ISVs to incorporate such functionality retrofitted into their stand-alone applications affording end-users a common usage model. An example of this usage is an ISV that had developed a stand-alone drawing application. Advantageously, the user 12 can use the invention to enable their application to communicate with one or more users wirelessly and all users can see and modify the drawing, as shown at 14 and 16.

A second embodiment of the present invention configured as a software program operating on a handheld computer 12, wirelessly communicating using the conference system to a machine 18 which is providing data. The user 12 can easily monitor real-time or near-real time information being produced by that's machines common interface and transmitted to the conference server via a gateway which is configured to allow such user secure or public access. The handheld application then displays the datastream using a software program that may graphically display the contents, allow manipulations of the data, and even route inputs and controls back to the machine. Advantageously, such a usage can enable, for example, a physician to monitor a patients EKG and vital signs in real-time while communicating with the hospital via a telephone thereby enabling more accurate diagnosis and treatment. Another example might be a building manager connecting to HVAC and electrical usage equipment to monitor a building's vital signs and even provide input back to the machines so that they can adjust their settings.

A third embodiment of the present invention configured as a software program operates in a handheld computer configured as an executive information exchange. The software can include a handheld productivity application such as a spreadsheet. The wireless handheld conference participants each have a copy of the spreadsheet automatically sent to their handheld computer from the participant designated as “host”, as shown at 16. Conference participants can make changes to the spreadsheet. All participants receive all the input from the each participant's handheld computers. The spreadsheet recalculations are executed locally using the processing power of each of the participants' devices. Advantageously, only inputs are transmitted between the handheld computers providing for exceptional application conferencing performance using today's widely available limited bandwidth technologies. In “Collaboration” mode conference participants can make changes anywhere in the workbook even on separate sheets within the workbook. All changes are sent to all the devices participating in the conference. In “Presenter” mode, one participant takes control of the presentation. The Presenter can scroll up/down left/right, change sheets, change the zoom to “present” information to all of the participants in the conference. Alternatively, a conference can be established between one or multiple users 12, 14 and 16 as well as users 22 who may have PC's linked via a desktop gateway 20, such as using WebEx 24 software, Chasseral 26 software, or Microsoft Net Meeting 28 software.

A fourth embodiment of the present invention configured as a software program operates in a handheld computer configured as an executive information exchange. The software can include a handheld productivity application such as a word processor. The wireless handheld conference participants each have a copy of the document automatically sent to their handheld computer from the participant designated as “host”. Conference participants can make changes to the document. All participants receive all the input from the each participant's handheld computers. The document recalculations for reformatting are executed locally using the processing power of each of the participants' devices. Advantageously, only inputs are transmitted between the handheld computers providing for exceptional application conferencing performance using today's widely available limited bandwidth technologies. In “Collaboration” mode conference participants can make changes anywhere in the document even in separate sections of the document. All changes are sent to all the devices participating in the conference. In “Presenter’ mode, one participant takes control of the presentation. The Presenter can scroll up/down, to “present” information to all of the participants in the conference.

A fifth embodiment of the present invention configured as a software program operates in a handheld computer configured as an executive information exchange. The software can include a handheld productivity application such as a slide presentation (Example; Microsoft PowerPoint for PCs). The wireless handheld conference participants each have a copy of the presentation automatically sent to their handheld computer from the participant that is initially the “host”. Conference participants can make changes to the presentation. All participants receive all the input from the each participant's handheld computers. The presentation slide rendering for display are executed locally using the processing power of each of the participants' devices. Advantageously, only inputs are transmitted between the handheld computers providing for exceptional application conferencing performance using today's widely available limited bandwidth technologies. In “Collaboration” mode conference participants can make changes anywhere in the presentation even in separate slides of the presentation. All changes are sent to all the devices participating in the conference. In “Presenter” mode, one participant takes control of the presentation. The Presenter can scroll up/down, zoom in or out, look at different views such as Outline or Notes, and flip slides to “present” information to all of the participants in the conference.

A sixth embodiment of the present invention provides a system for scheduling, establishing, managing, and billing for wireless conferences between two or more handheld users. This system is implemented on a server on behalf of clients that will communicate with the server using a handheld computer with transmission capabilities that enable the handheld computer to contact the server typically using TCP/IP to and over the Internet. Two or more participants connect to the server via a conference ID, username, and password that the system allows and then they each automatically retrieve the conference document and begin collaborative conferencing.

A seventh embodiment of the present invention provides for simultaneous voice communication concurrent with the data conference. This enhancement provides additional diverse commercial applications for the invention. Simultaneous voice and data (SVD) provided by the data carriers in hardware and software form is expected to be commercially deployed in the next couple of years and affords the present invention enhanced user experience more similar to existing wireline conferencing systems whereas the users of the invention can talk and share data at the same time.

Referring now to FIG. 2, the wireless collaboration conferencing according to the present invention is enabled by an application program 110 residing on each device adapted to perform wireless collaboration conferencing, including PDA device 100. The application module 110 is seen to include various modules which will first be discussed broadly, and then specifically.

The Personal Digital Assistant/Handheld Computer (PDA) 100 incorporates memory, central processing unit, operating system for system and user interface functions, storage, program execution.

The Application Program 110 implements functionality that can be enhanced by collaboration or conferencing technology.

The Desktop Computer 200 incorporates memory, central processing unit, operating system for system and ui behavior, storage, program execution.

The Event Loop 111 processes queues actions to be performed by the program 110.

The Conference and Collaboration Protocol (CCP) Event Handler 120 processes specific events produced by the CCP System Libray 160, and also makes calls to existing or new function blocks 130 within program.

The Application Program Function Blocks 130 are code segments which carry out actions in application program.

The CCP system library 160 implements the CCP API 170, and handles Conference Protocol messages (161), Filters Data Edit Messages (DEMs) (162), Display Update Messages (DUMs) (163), and manages connections.

The CCP API 170 is the conference and collaboration application programming interface that an application program implements and uses to incorporate CCP functionality in their program.

The Conference and Collabration Session 300 is an asynchronous data transfer between two or more connected PDAs 100 or Desktop Computers 200 implementing the CCP API 170.

Now, still referring to FIG. 2, CCP System Message 161 takes on the form documented in Conference and Collaboration Protocol which is provided in its entirety shorty.

CCP Data Edit Message (DEM) 162 and CCP Display Update Message (DUM) 163 also take on the form documented in Conference and Collaboration Protocol. Data Edit Messages 162 (DEMs) are used to classify blocks of data that are used by the remote computer to update the state of the data, as opposed to Display Update Messages 163 (DUMs) which update the state of the view. The distinction is such that the remote user can filter the receipt of DUMs 163 so that his display remains consistent as he is making changes to the collaborative data. The CCP Application Programming Interface (API) 170 takes on the form documented in the Conference and Collaboration API which is also provided in its entirety shortly.

Each Application Program 110 running on PDA 100 is a stand alone program that has suitable behavior and functionality to be a useful program in its own right. Extended and enhanced by the CCP System Library 160, it is able to communicate asynchronously with the same Application Programs 110 on a remotely connected PDA 100 via TCP/IP, Infrared, Bluetooth, or any other communications protocol that CPP System Library 160 implements. The lower level communication is transparent because the CCP System Library 160 provides such CCP API 170 to make it so.

The CCP Event Handler 120 decodes Data Edit Messages (DEMs) 162 and calls Application Program Function Blocks 130. Advantageously, by doing so, each Application Program 110 can be made to believe that the data it is operating on was generated locally, and as such, allows the Application Program 110 to carry out the action necessary without further modification. For example, the CCP Library 160 receives a Data Edit Message 162 which is coded by the implementor of the CCP API 170 to wrap the internal Application Program 110 memory structure which causes an action to be performed on, for example, a spreadsheet cell. The CCP Event Handler 120 unpacks this DEM 162 and fits it to the same structure in local memory, and calls the Application Program Function Block 130 to operate on the data. The effect is that with little or no modification to the existing application program, it operates on remotely generated data. Such simplicity is derived from the elegance of only sending the changed data resulting from an atomic user interface action and interpreting same on the participants handhelds via the reverse procedure thereby acting on only the changed data in the same or similar way to which the program would already operate on user entered data or user interface inputs. Identifying which data input and interface events to send and respond to is simplified by the inventions structure and engineering lead and implementers of the CCP API 170 typically only most be concerned with the same set of actions as their program already was handling.

The CCP Event Handler 120 which decodes Display Update Messages 163 and calls Application Program Function Blocks 130. By doing so, each Application Program can be made to believe that the data it is operating on was generated locally, and as such, allows the Application Program to carry out the action necessary without further modification. For example, when the CCP Library 160 receives a Display Update Message 163 which is coded by the implementor of the CCP API 170 to wrap the internal Application Program 110 memory structure which causes an action to be performed on the display, such as a screen tap, the CCP Event Handler 120 unpacks this DUM 163 and fits it to the same local memory structure, and calls the Application Program Function Block 130 to operate on the data. The effect is that with little or no modification to the existing application program, it operates on remotely generated actions and causes the application program to behave in such a way that the remote user is controlling the user local Application Program 110. Such simplicity is derived from the elegance of only sending the changed data resulting from an atomic user interface action and interpreting same on the participants handhelds via the reverse procedure thereby acting on only the changed data in the same or similar way to which the program would already operate on user entered data or user interface inputs. Identifying which data input and interface events to send and respond to is simplified by the inventions structure and engineering lead and implementers of the CCP API 170 typically only most be concerned with the same set of actions as their program already was handling.

The CCP System Library 160 processes a Conference System Message 161 in such a way as to be able to connect to and receive connections from a remote Application Program 110 running on another PDA 100 which implements the CCP API 170. Advantageously, the Application Program 110 need not know how to make a TCP/IP, IP, Bluetooth connection with a remote device, need not know how to disconnect from such connection, nor need not know how to implement the specific rules of communication with such protocols. Rather, the Application Program 110 need only know that it will receive messages from the CCP System Library 160 which will be transferred to the Application Program 110 and handled by the custom CCP Event Handler 121.

The CCP System Library 160 is able to filter Display Update Messages 163 to enable each remote Application Program 110 to determine whether only data or display events will be processed. Advantageously, this enables the remote Application Program 110 user to concurrently enter and modify data on the PDA 100 or Desktop Computer 210 while still participating in the Collaboration and Conference Session 300.

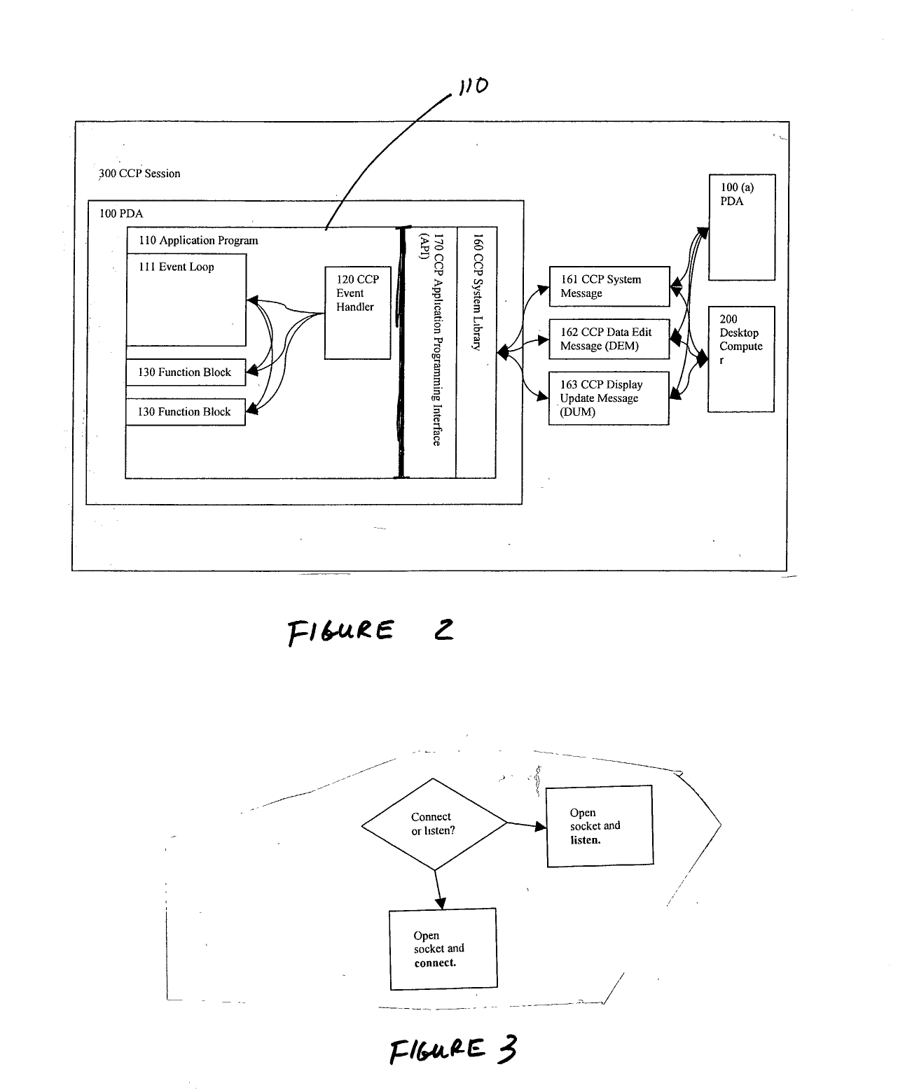

Each Desktop Computer 210 can implement the CCP API 170 in the same way as the described PDA 100 above. Further, the Desktop Computer 210 can take the form of an embedded data generating device such as a heart monitor, HVAC system, or manufacturing equipment. In this scenario these devices implement only the Data Edit Message 161 and allow for remote monitoring, and even control of said device or hardware, as shown in FIG. 3.

The existing application that links to and implements the CCP API 170 makes the appropriate setup method calls, and then tells the CCP System Library 160 to either connect or wait for a connection (listen). When the connection is made, the Application Program 110 is notified of this action via an event which is handled by the CCP Event Handler 120.

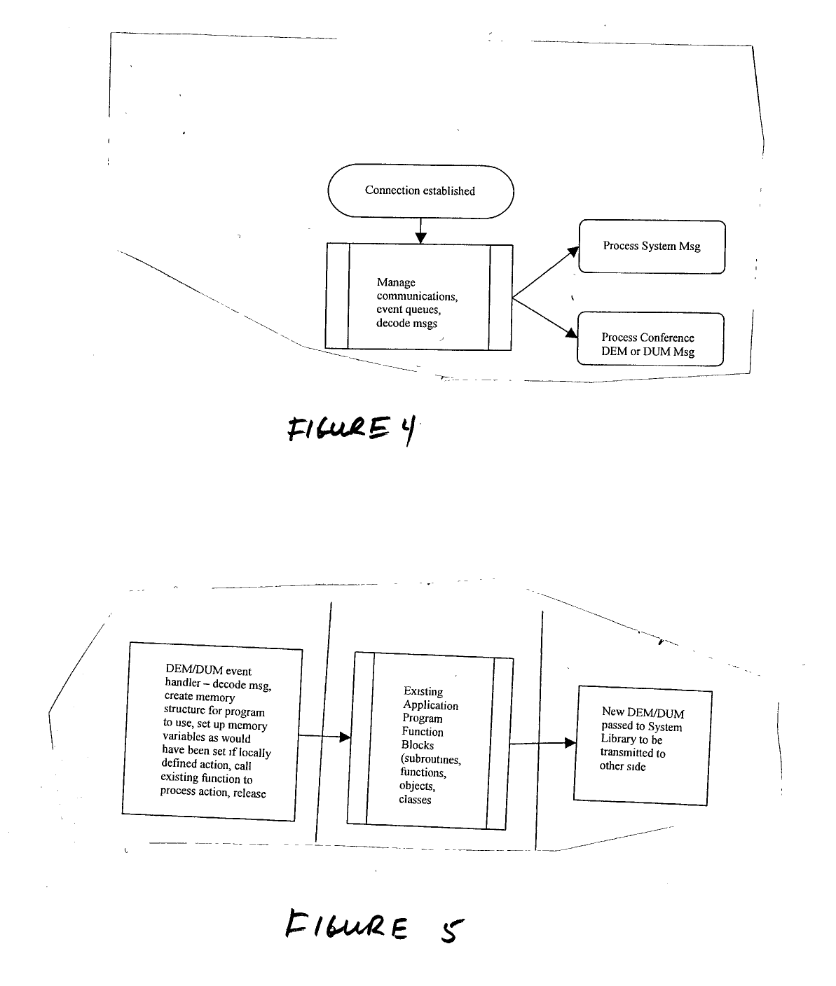

The CCP Event Manager 170 receives messages in the form of a structured set of bytes. These bytes are overlayed onto documented programmatic structure allowing them to be interpreted as an application specific msg_id and payload, as shown in FIG. 4. The payload has program or message specific data. System Messages 161 are sent between the CCP System Library 160 on both sides to bring up a conference, bring down a conference, accept new entities into the conference, send text messages, send and receive error messages, enqueue and dequeue communications blocks, send and receive conference documents and various other protocol related implementations as described in the Conference and Collaboration Protocol as will be discussed in its entirety shortly.

Application specific events, such as DEM 162 and DUM 163 messages, are the most interesting as they pertain to actual wireless collaborative sessions, as shown in FIG. 5. Each Data Edit Message 162 is designed to correspond to one atomic data edit operation. As an example, in the case of spreadsheet collaboration, if a cell's formula were to be edited, the originating application client creates and packages a DEM 162 with the row, column, and formula for the newly edited cell. The destination client application receives this DEM 162, matches the conference msg_id and application specific msg_id to that of a formula edit, unpacks the payload, and calls the appropriate application level function or subroutine to handle a cell formula edit. Advantageously, this enables the client program to be coerced into thinking that the data was originated locally and avoids application program redesign or significant additional programming on already tested application code.

Display Update Messages 163 are those that control the User Interface. An example is scrolling. If the originating client application needs to notify the conference that it has scrolled, it packages up a scroll event and sends it as a DUM. The DUM, when received by receiving clients, is matched against the msg_id and then a scroll event is interpreted. This scroll event is then created at each receiving client, as the client application would have done so internally, and the appropriate function call is made so that each receiving client program is coerced into thinking the event was triggered locally. Advantageously, this avoids significant redesign of the client program and avoids touching code that may be already well tested.

The DUM 163 is unique in that the CCP System Library 160 is able to selectively filter DUM messages 163 if the receiving client application tells it to. This advantageously enables the receiving client application to be a data participant the in the conference, yet not have the screens user interface moving about causing difficulty in making simultaneous edits. The Conference and Collaboration Protocol 160 and Conference and Collabration API 170 describe in detail how to make the appropriate function calls to enable or disable DUM events, as now described.

### Collaboration Protocol Specification (CCP)

Introduction

The Collaboration Protocol is a transport-independent protocol intended to enable both peer devices to connect to each-other and clients to connect to servers, to exchange various forms of content. The formats of the actual content exchanged is described in this document but is considered to be a function of the applications using the protocol. It is worth noting that this protocol is both transport-neutral and content-neutral. The protocol itself is extensible to additional content formats.

In this document wherever the term passive device is used the term relay server can be substituted for a client-server situation.

The initial version of the protocol will reference two transports (IrDA and TCP/IP) but the assumption is that adding support for another protocol will not impact this document.

All 16-bit and 32-bit integers in the protocol headers will be converted to network-byte order before being sent to the peer device.

For all structure definitions, constants, and enumerated types, see the Collab.h file. For the API definition see Collaboration_ptcl_spec.doc.

The following is an architectural overview of where the Collaboration Protocol exists in the framework of two devices communicating.

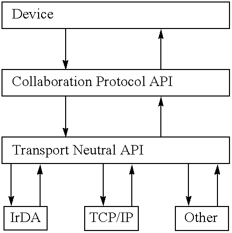

This document describes the data flowing between the Collaboration Protocol API and the Transport Neutral API.

### MESSAGE OVERVIEW

This section defines in full detail the Collaboration Protocol messages.

For all Collaboration Protocol messages, the fields of the initial 16 bytes are identical:

Bytes In Message (4 bytes)
Message Type (4 bytes)
Protocol Version (2 bytes)
Conference ID (2 bytes)
User ID (2 bytes)
Reserved (2 bytes)

Bytes In Message—The number of bytes in this entire Collaboration Protocol message, including the header. The receiving device can use this value to keep reading on the transport until it receives all the bytes in the message before delivering to the application. Reminder: all 16 and 32 bit integers are sent in network byte order.

Message Type—There are four groups of messages and the group a particular message belongs to is determined by bit masks.

0×------01 to 0×------FF: system messages (if msg & 0×000000FF)

0×----01-- to 0×----FF--: conference messages; typically relayed on to all other conference participants (if msg & 0×0000FF00)

0×--01---- to 0×--FF----: user defined messages (if msg & 0×00FF0000)

0×01------ to 0×FF------: reserved

For system messages the following are defined:

| Message | Value |
|---|---|
| clbSysConnectRequest | 0x00000001 5 |
| clbSysConnectResponse | 0x00000002 |
| clbSysConfIDRequest | 0x00000003 |
| clbSysConfIDResponse | 0x00000004 |
| clbSysJoinConference | 0x00000005 |
| clbSysLeaveConference | 0x00000006 |
| clbSysUserStatus | 0x00000007 |
| clbSysNewDocument | 0x00000008 |
| clbSysGetDocument | 0x00000009 |
| clbSysSetDocument | 0x0000000A |
| clbSysSetDocumentResponse | 0x0000000B |
| clbSysSetDisplayUpdateState | 0x0000000C |
| clbSysBaton | 0x0000000D |
| clbConfDataUpdate | 0x00000100 |
| clbConfDisplayUpdate | 0x00000200 |
| clbConfText | 0x00000300 |

Protocol Version—Most significant byte contains major version number. Least significant byte contains minor version number. For version 1.02 this value will be 0×0102

Conference ID—This value must have been communicated to the user prior to the start of the Collaboration session and entered by the user via some input method on the client device. For peer-to-peer conferences this value must be 0×FFFF. The exception is for the clbSysConfIDRequest and clbSysConfIDResponse messages in which the values must be 0×FFFF.

User ID—This value must have been communicated to the user prior to the start of the Collaboration session and entered by the user via some input method on the client device. For peer-to-peer conferences this value must be 0×FFFF. This value serves two purposes:

validate that this user belongs to this particular conference

identify this user/device in subsequent messages from this device The relay server (or passive device) must validate and store this value and use it to recognize this particular client. It is analogous to a username.

### SYSTEM MESSAGES

System Messages can be sent from clients to the relay server, from the relay server to clients, or from peer to peer. System messages are not automatically forwarded to the other client devices by the relay server. They are used to indicate some type of interaction specific to the relationship between a particular client and the relay server.

A System Message can be determined by masking off the upper 24 bits of the 32 bit message type (after converting to host-byte order). For example:

if ( msg & 0x000000FF )
// it's a system message

clbSysConnectRequest (0×00000001)

This message is sent from the active device (the one initiating the transport connection) to the passive device immediately after the transport connection is active. It must be the first message exchanged.

The message payload for this message is as follows:

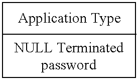

The application type is in the ConnectRequest message so that the passive device may reject the session if the application isn't supported or does not match the conference. The following application types are defined:

clbAppTypeIM=1

clbAppTypeQuickWord=2

clbAppTypeQuickSheet=3

The password is sent unencrypted.

clbSysConnectResponse (0×00000002)

This message is sent from the passive (listening) device to the active device in response to receiving a clbSysConnectRequest message. The passive device will verify the conference ID, participant ID, and password, and will send this message as a response. The purpose is to indicate whether the information is valid, and possibly to redirect the active device to another address and/or port number.

The message payload for this message is as follows:

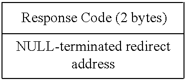

The response code will one of the following:

ETClbResponseAcceptNoRedirect (0×0001)—valid conference and user ID; this conference is hosted on this device.

ETClbResponseAcceptRedirect (0×0002)—valid conference and user ID; client must disconnect and reconnect to address provided.

ETClbResponseRejectBadConfID (0×0003)—unknown conference

ETClbResponseRejectBadConfTime (0×0004)—known conference but it isn't going on right now.

ETClbResponseRejectBadUserID (0×0005)—user id not valid for this conference

ETClbResponseRejectBadPassword (0×0006)—username valid but password is not

ETClbResponseRejectUnsupportedApp (0×0007)—requested application not supported by passive device

ETClbResponseRejectMaxClients (0×0008)—maximum number of clients are already connected.

ETClbResponseRejectByUser (0×0009)—rejected by user

ETClbResponseRejectOther (0×000A)—unspecified rejection

Upon receipt of any of the rejections the active side must close the transport connection. In the event the transport connection is not closed the passive side will ignore any further messages received on the connection.

Upon receipt of the ETClbResponseAcceptRedirect message the active side must close the connection, parse the new address, and attempt to connect to the new host of the conference. The transport is assumed to be the same as the current transport. The address is in ASCII format with the following structure for TCP/IP: host-name or IP address octet followed by the character ‘:’ followed by the port number followed by the NULL terminator. For example: “yahoo.com:9800” or “192.168.1.3:9778”.

clbSysConfIDRequest (0×00000003)

The purpose of this message is to provide a way for passive devices in a peer-to-peer conference to not require the active side to have its IP address. Instead a conference ID will be used to address the passive device. The passive device will connect to a server whose role is to associate conference ID's and IP addresses and send this message as the first message. The server will respond with a clbSysConfIDResponse message with a new conference ID. The server will log the conference ID and the IP address and then when the active peer tries to connect to a well-known server it will be redirected to the passive device.

The conference ID in the message header must be 0×FFFF.

The message payload for this message is as follows:

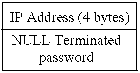

The IP address is sent in network-byte order.

The password is sent unencrypted and must be NULL terminated.

clbSysConfIDResponse (0×00000004)

This message is sent from a conference ID server application to a client upon receipt of a clbSysConfIDRequest message.

The conference ID in the message header must be 0×FFFF.

The message payload for this message is as follows:

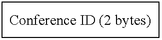

The conference ID in the payload must be in network-byte order

clbSysJoinConference (0×00000005)

This message is sent from the active device (the one initiating the transport connection) to the passive device immediately after the Collaboration session has been established. Passive peer devices can ignore the message. Relay servers must do the following:

if this is the first user for this conference then the conference is started

if this is not the first user for this conference and this conference has not been set up as a “public” conference then the relay server generates and sends a clbSysUserStatus message to all existing conference participants notifying them that this user has joined the conference

The message payload for this message is as follows:

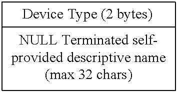

the device-type is one of the following:

0×0001: PalmOS PDA

0×0002: PocketPC PDA

0×0003: J2ME display device

(add more as necessary)

The self-provided descriptive name will be sent to other conference participants when users join or leave a conference. This must be NULL terminated. Relay servers should associate this field with this user in its internal structures.

clbSysLeaveConference (0×00000006)

This message is sent from clients to the relay server when they are leaving the conference. It usually immediately preceeds a transport connection shutdown by the client device. Passive peer devices can ignore the message. Relay servers must do the following:

if this is the last user for this conference then the conference is shut down

if this is not the last user for this conference and this conference has not been set up as a “public” conference then the relay server generates and sends a clbSysUserStatus message to all existing conference participants notifying them that this user has signed off the conference

There is no message payload for this message.

clbSysUserStatus (0×00000007)

This message is sent from the relay server to active client devices when a user has either joined or left the conference.

The message payload for this message is:

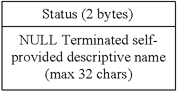

The status is either:

0×0001: user has joined conference

0×0002: user has left conference

The descriptive name is the same as that provided by this client in the clbSysJoinConference message.

clbSysNewDocument (0×00000008)

This message is sent from the relay server to client devices upon receipt of a clbSysSetDocument message from one of its clients. Its purpose is to notify the remaining clients that the conference document is available to be retreived. Normally the client devices will then send a clbSysGetDocument message to the relay server to obtain the document.

This message is not valid for peer-to-peer Collaboration sessions and must be ignored by receiving devices in this situation.

The payload of this message contains:

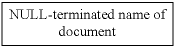

clbSysGetDocument (0×00000009)

This message is sent from clients to relay servers or from peer-to-peer. The purpose is to obtain the conference document.

Upon receipt of this message the relay server or the receiving peer device must send the document to the client in a clbSysSetDocument message.

The payload of this message contains:

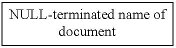

If there is no document name in the message (indicated by either no bytes at all in the payload or a single 0 byte [the empty string]) it is assumed the receiving device knows which document is the conference document and will respond with it in the clbSysSetDocument message.

clbSysSetDocument (0×0000000A)

There are three situations in which this message can be sent:

when a peer device wants to send the conference document to the relay server so that it may then be distributed to the other clients.

when the relay server wants to send the conference document to the clients.

when two peer devices are conferencing and one wants to send the conference document to the other.

Upon receipt of this message the receiving client device must read the entire message to obtain the document itself and save the document to “disk”.

When relay servers receive this message they must notify all the other clients that a new conference document is available via a clbSysNewDocument message. The clients then have the option of obtaining the new document with a clbSysGetDocumentMessage.

The payload of this message contains:

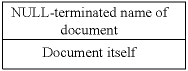

The device receiving the document can determine when the entire document has been received using the total-bytes field of the message header. Once the entire document has been received and saved the application can act upon the document (perhaps by loading it).

clbSysSetDocumentResponse (0×0000000B)

This message is sent from clients to relay servers or from peer-to-peer. The purpose is to let the other side know that it received the conference document just sent in a clbSysSetDocument message.

The payload of this message contains:

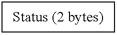

The status is either:

CLB_SETDOCRESPONSE_OK (1): No errors

CLB_SETDOCRESPONSE_ERR (2): Document was not received intact.

clbMsgSetDisplayUpdateState (0×0000000C)

This message is used to specify if the device sending it wants to or does not want to receive Display Update Messages (DUMs).

The two byte payload contains:

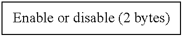

The status is either:

CLB_DISPLAYUPDATE_ENABLE (1)—yes, send me DUMs.

CLB_DISPLAYUPDATE_DISABLE (2)—no, do not send me DUMs.

clbMsgBaton (0×0000000D)

This message is used to communicate requests and responses to requests for the baton. When a conference is in “projector mode” only one device can send Display Update Messages (DUMs) and Data Edit Messages (DEMs). It must possess the baton in order to send these messages.

The payload for this message contains:

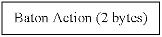

The baton action must be one of the following:

CLB_BATON_REQUEST (1)—the sender is requesting the baton

CLB_BATON_GRANTED (2)—the sender is granting possession of the baton

CLB_BATON_GRANTED_DUE_TO_TIMEOUT (3)—the device that possesses the baton did not respond to the baton request and therefore gives up possession of the baton

CLB_BATON_DENIED (4)—the sender is denying the request to give up the baton

CLB_PROJECTOR_MODE_CANCELLED (5)—the conference is leaving projector mode.

Conference Messages

Conference messages can be sent from clients to the relay server, from the relay server to clients, or from peer to peer. Conference messages are automatically forwarded to the other client devices by the relay server (but not back to the originating device).

A conference message can be determined by masking off the upper 16 bits and the lower 8 bits of the 32 bit message type. For example:

if ( msq & 0x0000FF00 )
// it's a conference message

For conference messages originating on a client (i.e. not relayed to the client by the relay server) the user-ID in the header is its own user-ID. For conference messages relayed to clients by the relay server the user-ID in the header is the originator's user-ID.

clbConfDataUpdate

This message is used to indicate some type of change in the conference document. It can be sent from client to relay server, relay server to clients, or from peer-to-peer. Upon receipt of this message the relay server will forward the message unchanged to the other clients. The relay server will also update the master document. [not in initial version]

The payload of this message is dependent upon the applications that are conferencing. It is the application's responsibility to format the data for this message. The protocol will simply set the message type in the message header to clbConfDataUpdate and deliver the data to the recipient.

In order for the application to determine if it can interpret and handle the data the protocol specifies that the first tow bytes of the message will contain fields for version of the data contained in the message.

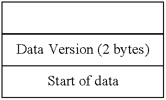

clbConfDisplayUpdate

This message is used to indicate some type of change in the display of the conference document. It can be sent from client to relay server, relay server to clients, or from peer-to-peer. Upon receipt of this message the relay server will forward the message unchanged to the other clients.

The payload of this message is dependent upon the applications that are conferencing. It is the application's responsibility to format the data for this message. The protocol will simply set the message type in the message header to clbConfDisplayUpdate and deliver the data to the recipient.

In order for the application to determine if it can interpret and handle the data the protocol specifies that the first four bytes of the message will contain fields for application type and version of the data contained in the message.

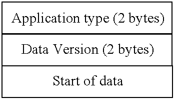

clbConfText

This message can be sent from client devices to the relay server, from the relay server to client devices, or from either peer in a peer-to-peer session, at any time after the Collaboration session has been opened.

In addition to the message header described previously the clbConfTextMsg contains NULL terminated ASCII text for the message immediately following the header.

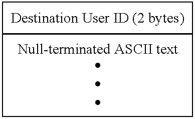

if the text is to be delivered to just one user that user-ID must be placed in the first two bytes. If the message is to be delivered to all users, or this is a peer-to-peer conference, then the value 0×FFFF must be in the first two bytes.

Session Shutdown

Either the passive or the active device can close the Collaboration session at any time simply by closing down the transport connection.

### Conferencing and Collaboration Protocol API (CCP API)

Control Block

The structure referred to as the control block is passed into every function of the Collaboration layer and is also passed by the Collaboration layer into the transport modules. It can be considered the master structure of the entire protocol stack. It tracks state, address, connection type, number of bytes received for the current incoming message, and other things. This structure is declared in the main module interfacing with the Collaboration layer and also available as an extern in the module the contains the main application event loop.

There is little reason the application should be either reading or changing the variables in the control block structure. Those instances are noted in this document.

TSRCt1Block gCt1Block;

Function API

clbGetLibVersion

UInt16 clbGetLibVersion( void );

Description: Get the version of the Collaboration library. Note this is independent of the Collaboration protocol version.

EXAMPLE

if ( clbGetLibVersion() != 0x0103 );
// error

clbRun

void clbRun( void );

Description: Check for pending events, write any pending outgoing messages, and give the SR (transport) layer some CPU time. This function must be called from the loop in the application's main event loop.

EXAMPLE

// in the app's main event loop.
do
{

clbRun ( &gCtlBlock );
EvtGetEvent (&event, 10 );
// Ask system to handle event.
if (false == SysHandleEvent (&event))
// rest of system event handlers . . .

clbConnect

Err clbConnect ( TSRCtlBlock *ctlBlock,

TOutputType xPort,
UInt32 confID,
UInt32 userID,
UInt16 appType,
Char *passWord );

Description: Starts the process of establishing a Collaboration session. The application must set the type of connection desired before calling this routine. It must also set the IP address and port in ct1Block before calling if attempting a TCP/IP connection. This is an asynchronous call. The caller will be notified of a connection via a CLB_CONNECTION_UP event on the event queue.

Parameters:

| | |
|---|---|
| ctlBlock | pointer to master control block |
| xPort | transport type (IR or TCP/IP, see sr.h) |
| confID | conference id; entered by user via UI |
| userID | user id; entered by user via UI |
| appType | application; known by application. e.g. QuickWord |
| passWord | Password for this user. Null-terminated. |

EXAMPLE

gCtlBlock.connType = appPrefs->LastTransport; // IR or TCP/IP
gCtlBlock.connHdl = −1;
gCtlBlock.passiveMode = false;
gCtlBlock.bytesRcvdThisMsg = 0;
gCtlBlock.bytesExpectedThisMsg = 0;
gCtlBlock.confID = prefs.confID;
gCtlBlock.userID = prefs.userID;
bCtlBlock.bReceivingDocument = false;
StrCopy( gCtlBlock.passWord, pGadget->appPrefs->LastPassword );
// set up address stuff
if ( gCtlBlock.connType == ETOutputTCPIP )
{

StrNCopy ( gCtlBlock.info.TCPIPInfo.addrString,

“192.168.1.1”,
MAX_IPADDRESS_CHARS );

// port is in host-byte order
gCtlBlock.info.TCPIPInfo.portNum = StrAToI ( COLLABORATION_PORT

);

}
else // has to be IR for this version
{

// nothing to do

}
if ( clbConnect ( &gCtlBlock,

gCtlBlock.connType,
gCtlBlock.confID,
gCtlBlock.userID,
ETAppTypeQuickword,
gCtlBlock.passWord ) != ETCLBOK )

{

FrmCustomAlert( ErrorAlert, “Error starting connection”, NULL,

NULL );

}

// now wait for CLB_CONNECTION_UP event

clbListen

Err clbListen( TSRCtlBlock *ctlBlock, clbAppAcceptSessionCB
acceptSessCB );

Description: Starts “listening” on the specified connection type. The connection type is specified in the ct1Block.connType field. Set it to the desired transport before making this call. This is an asynchronous call. When a connection is established the caller will be notified via the CLB_CONNECTION_UP event on the event queue.

Parameters: ct1Block Pointer to connection control block. acceptSessCB Pointer to callback function to verify acceptance of session.

EXAMPLE

gCtlBlock.connType = ETOutputTCPIP; // or ETOutputIR
gCtlBlock.connHdl = −1;
gCtlBlock.passiveMode = true;
gCtlBlock.confID = 0;
gCtlBlock.userID = 0;
gCtlBlock.bytesRcvdThisMsg = 0;
gCtlBlock.bytesExpectedThisMsg = 0;
gCtlBlock.bReceivingDocument = 0;
if( gCtlBlock.connType == ETOutputTCPIP )
{

gCtlBlock.info.TCPIPInfo.addrString[0] = 0;
gCtlBlock.info.TCPIPInfo.portNum = StrAToI( COLLABORATION_PORT

);

}
if( clbListen( &gCtlBlock, AcceptSessionFunc ) != ETCLBOK )
{

FrmCustomAlert( ErrorAlert, “Error listening”, NULL, NULL );

}

clbGetConfID
Err clbGetConfID( TSRCtlBlock *ctlBlock,

TOutputType xPort,
UInt32 userID,
Char *passWord );

Description: Starts the process of obtaining a conference ID for a new conference. In a peer-to-peer conference the passive device will call this function to register its IP address with a well-known server. An active client can then use the conference ID returned to the passive device to connect to the passive device by connecting to the well-known server and then being redirected.

The results from this call will be passed to the application via the CLB_CONFID event in which the evtData32 will contain the new conference ID. The application should then call clbListen to go into listen mode.

Parameters:

| | |
|---|---|
| ctlBlock | pointer to master control block |
| xPort | transport type (IR or TCP/IP, see sr.h) |
| userID | user id; entered by user via UI |
| passWord | Password for this user. Null-terminated. |

EXAMPLE

| | |
|---|---|
| if( clbGetConfID( | &gCtlBlock, |

gCtlBlock.connType,
gCtlBlock.userID,
gCtlBlock.passWord ) != ETCLBOK )

{
FrmCustomAlert( ErrorAlert, “Error getting Conference ID”,

NULL, NULL );

}

clbSendMsg
Err clbSendMsg( TSRCtlBlock *ctlBlock, TClbMsg *clbMsg );

Description: Writes the data in the Collaboration message to the current connection. The caller is expected to create the message using the clbCreate call, copy the data into the buffer, then call this function to do the writing. This is an asynchronous call. The caller will be notified of successful completion of the write via an event on the event queue.

Parameters:

| | |
|---|---|
| ctlBlock | Pointer to master control block |
| outBuf | Pointer to buffer to be written. |

Returns:

| | |
|---|---|
| ETCLBOK | No error. |
| ETCLBErr | Can't send this message because the stack is currently |
| | busy sending another message or there are too many |
| | pending outgoing messages in the queue. |
| ETCLBErrState | Won't write this message due to a state issue, for |
| | example, trying to send a display update message |
| | while you don't have the baton. |

EXAMPLE

Char localBuf[MAX_TEXT_LEN], *payLoad;
TClbTextMsg *clbMsg;
// create a Collaboration message (text to be sent
is already in
// “localBuf”)
clbMsg = (TClbTextMsg *)clbCreate( clbMsgTextMsg,

gCtlBlock.confID,
gCtlBlock.userID,
StrLen( localBuf ) + 3 );

// copy the data in
payLoad = (Char *)CLB_BUF_ADDR( clbMsg ) + 2;
payLoad[0] = 0;
StrCopy( payLoad, localBuf );
// send it out
if( clbSendMsg( &gCtlBlock, (TClbMsg *)clbMsg ) !=
ETCLBOK )
}
FrmCustomAlert( ErrorAlert, “Error updating remote device”,

NULL, NULL );

}
// wait for confirmation of send via the
CLB_WRITE_COMPLETE

message

// before sending another

clbDisconnect
Err clbDisconnect( TSRCtlBlock *ctlBlock );

Description: Disconnects the open connection. This is an asynchronous call. The caller will be notified the connection is closed via an event on the event queue. A clbMsgLeaveConference message will be sent out prior to shutting down the connection.

Parameters:

| | |
|---|---|
| ctlBlock | Pointer to master control block |

clbCreate

TClbHeader *clbCreate( ETClbMsg msgType, UInt16 confID,
UInt16 userID,
Int32 numBytes );

Description: Creates a Collaboration message with the header filled an and the payload ready to be filled. The number of bytes is the number needed for the payload only; this function will automatically account for the room for the header. It returns a pointer to the message header (and therefore the message itself). Use the CLB_BUF_ADDR macro to get access to the “payload” address.

Parameters:

| | |
|---|---|
| Message type | Example: clbMsgConfText, clbMsgConfDataUpdate. |
| Conference ID | Unique ID to identify desired conference to server. |
| User ID | Unique ID to identify this user to server. |
| Number of bytes | Payload only; do not count message header. |

EXAMPLE

### (For Example Use See Comments for clbSendMsg)

clbSendDocument

Err clbSendDocument( TSRCtlBlock *ctlBlock, Char *docName, UInt16
confID, UInt16 userID );

Parameters:

| | |
|---|---|
| ctlBlock | Pointer to connection control block. |
| docName | Name of document to send (NULL terminated) |
| conference ID | Conference ID for current conference. |
| user ID | User ID |

Description: Creates a new clbSysSetDocument message with the correct header information, sends the message out, and also finds the document database and sends it.

EXAMPLE

clbSendDocument ( ctlBlock, “budget2002.pdb”,

ctlBlock->confID, ctlBlock->userID );

Note: This is an asynchronous message and will result in a CLB_WRITEDOC_COMPLETE event being sent to the application after the receiving device has acknowledged receipt of the document with a clbMsgSetDocumentResponse message.

clbChangeState

void clbChangeState( TSRCt1Block *ct1Block, TStatusType newState );

Description: Changes state variable member of the control block to new state. Valid states are defined by the TStatusType typedef:

typedef enum

{

//active and passive states

ETConnStatusDown,

ETConnStatusUp,

//active states

ETConnStatusUpPending,

ETConnStatusAuthOutPending,

//passive states

ETConnStatusListenPending,

ETConnStatusListening,

ETConnStatusAuthInPending,

ETConnStatusDownPending

}TStatusType;

The application should only ever use ETConnStatusDown, ETConnStatusUp, ETConnStatusListenPending, and ETConnStatusListening. The other states are managed internal to the Collaboration module. For example,

The application must

set the state to ETConnStatusUp upon receipt of the CLB_CONNECTION_UP event

set the state to ETConnStatusDown upon receipt of the CLB_CONNECTION_DOWN event

set the state to ETConnStatusDown right before starting a new connection

set the state to ETConnStatusListenPending right before calling clbListen

set the state to ETConnStatusDown when canceling a listen

Parameters:

| | |
|---|---|
| ctlBlock | Pointer to control block |
| new state | See valid states above. |

EXAMPLE

clbChangeState( &gCt1Block, ETConnStatusUp );

clbGetPeerName

void clbGetPeerName( TSRCtlBlock *ctlBlock, Char *peerName, Int16
maxChars );

Description: Makes call to transport (SR) layer to get the name in string format of the connected device. Will return result in NULL-terminated form in peerName. The name will be dependent upon the transport. For example, for TCP/IP it will return an IP address in the form of “192.168.1.1”.

Parameters:

| | |
|---|---|
| ctlBlock | Pointer to control block |
| peerName | Buffer to place result |
| maxchars of peerName | Size of buffer |

clbGetLocalAddr

void clbGetLocalAddr( TSRCtlBlock *ctlBlock, Char *localAddr, Int16
maxChars );

Description: Makes call to transport (SR) layer to get the name in string format of this, the local, device. Will return result in NULL-terminated form in localAddr. The name will be dependent upon the transport. For example, for TCP/IP it will return an IP address in the form of “192.168.1.1”.

Parameters:

| | |
|---|---|
| ctlBlock | Pointer to control block |
| localAddr | Buffer to place result |
| maxchars of localAddr | Size of buffer |

clbAppAcceptSessionCB

typedef ETClbResponse (*clbAppAcceptSessionCB) (Char *userID,

Char *passWord,
UInt16 appType,
Char *remoteAddr );

Description: Application callback function to verify if application wants to accept incoming sessions. This is passed in as a parameter to the clbListen call. Passing NULL implies approval of all incoming sessions. When an incoming session comes in the library will call this function and react according to the response indicated by the return code.

clbGetConfStatus

UInt16 clbGetConfStatus( TSRCt1Block *ct1Block );

Description: Returns the internal variable that tracks the following:

if conference is in projector mode or not (PROJECTOR_MODE)

if this device has baton or not (HAVE_BATON)

An application can check the status of the bit fields using this call.

Parameters:

ct1Block Pointer to connection control block.

EXAMPLE

if( clbGetConfStatus( ct1Block ) & PROJECTOR_MODE )

clbRequestBaton

UInt16 clbRequestBaton( TSRCt1Block *ct1Block );

Description: Creates and sends out a clbMsgBaton message with CLB_BATON_REQUEST in the messages payload. Starts a timer so that if the other side doesn't respond within BATON_REQUEST_TIMEOUT seconds the stack will send up a CLB_BATON_STATUS event with a GRANTED status.

Parameters:

ct1Block Pointer to connection control block.

Returns:

| | |
|---|---|
| ETCLBOK | No error. |
| ETCLBErr | Another baton request is pending (withing the timeout |
| | period). |

EXAMPLE

clbRequestBaton( &gCt1Block );

clbRegisterEventCB

void clbRegisterEventCB( callBackFuncPtr );

Description: Register a callback function that will be called when the stack has an event to send to the application. The events that can be sent are listed in the Events section.

Parameters:

callBackFuncPtr Pointer to callback function that will handle the event. This function must have the following prototype:

Boolean CBFunc( QEventType *evt, void *ptr );

The callback function must return true if it handled the event and false otherwise.

EXAMPLE

clbRegisterEventCB( myEventHandler );

Constants

This section will list the constants (#defines) and types (typedefs) used in the Collaboration protocol.

CLB_VERSION

Simple version value. Two bytes. Most significant byte is major version; least significant byte is minor version. This value is placed into every Collaboration message header by the Collaboration layer.

#define CLB_VERSION 0x0102 // hi byte major version,
lo byte minor
version

CLB_LIB_VERSION

Library version number. Two bytes. Most significant byte is major version; least significant byte is minor version. The library version is independent of the protocol version.

#define CLB_LIB_VERSION 0x010A // hi byte major version,
lo byte
minor version

Error Codes

These are used both as return values from the API calls and possibly passed to the application via events.

| | |
|---|---|
| #define ETCLBOK | 0 |
| #define ETCLBErr | −1 |
| #define ETCLBErrState | −2 |
| #define ETCLBErrPendingOutMsgs | −3 |

Message Types

The application will never send or receive either a clbMsgConnectRequest, clbMsgJoinConference, clbMsgLeaveConference, clbMsgUserStatus, or a clbMsgConnectResponse message; those are sent and handled by the Collaboration layer. The application will pass one of the other valid types into the clbCreate call.

/***

Collaboration message types
0x000000FF = system messages
0x0000FF00 = conference messages
0x00FF0000 = user-defined messages
0xFF000000 = undefined, reserved

| ***/ | |
|---|---|
| #define clbMsgConnectRequest | 0x00000001 |
| #define clbMsgConnectResponse | 0x00000002 |
| #define clbMsgConfIDRequest | 0x00000003 |
| #define clbMsgConfIDResponse | 0x00000004 |
| #define clbMsgJoinConference | 0x00000005 |
| #define clbMsgLeaveConference | 0x00000006 |
| #define clbMsgUserStatus | 0x00000007 |
| #define clbMsgNewDocument | 0x00000008 |
| #define clbMsgGetDocument | 0x00000009 |
| #define clbMsgSetDocument | 0x0000000A |
| #define clbMsgSetDocumentResponse | 0x0000000B |
| #define clbMsgSetDisplayUpdateState | 0x0000000C |
| #define clbMsgBaton | 0x0000000D |
| #define clbMsgSetDocumentReady | 0x0000000E |
| #define clbMsgConfDataUpdate | 0x00000100 |
| #define clbMsgConfDisplayUpdate | 0x00000200 |
| #define clbMsgConfText | 0x00000300 |
| #define CLB_SYSMSG_MASK | 0x000000FF |
| #define CLB_CONFMSG_MASK | 0x0000FF00 |
| #define CLB_USERMSG_MASK | 0x00FF0000 |
| #define CLB_RESERVEDMSG_MASK | 0xFF000000 |

COLLABORATION_PORT

TCP port for the Collaboration protocol. Passive devices will listen on this port. Active devices will connect to this port. If this protocol becomes part of a product a port will have to be registered with IANA (Internet Assigned Numbers Authority).

#define COLLABORATION_PORT 9800

CLB_HEADER_BYTES

Number of bytes in the Collaboration message header.

#define CLB_HEADER_BYTES (sizeof(TClbHeader))

CLB_BUF_ADDR

Macro to allow quick and easy access to the pointer to the “payload” in a Collaboration message.

#define CLB_BUF_ADDR(x) (((UInt8 *)x)+CLB_HEADER_BYTES)

CLB_EVT_XXX_BASE

This values are base values to which a value is added to obtain a unique event number.

| | |
|---|---|
| #define CLB_EVT_SYS_BASE | 0 |
| #define CLB_EVT_CONF_BASE | 1000 |
| #define CLB_EVT_USER_BASE | 2000 |

CLB_Message Constants

These values are associated with messages that go on the wire. The message they are associated with can be ascertained from the constant name.

| | |
|---|---|
| #define CLB_DISPLAYUPDATE_ENABLE | 1 |
| #define CLB_DISPLAYUPDATE_DISABLE | 2 |
| #define CLB_BATON_REQUEST | 1 |
| #define CLB_BATON_GRANTED | 2 |
| #define CLB_BATON GRANTED_DUE_TO_TIMEOUT | 3 |
| #define CLB_BATON_DENIED | 4 |
| #define CLB_PROJECTORMODE_CANCELLED | 5 |
| #define CLB_SETDOCRESPONSE_OK | 1 |
| #define CLB_SETDOCRESPONSE_ERR | 2 |
| #define CLB_USERSTATUS_JOIN | 1 |
| #define CLB_USERSTATUS_LEAVE | 2 |

Enumerated Types

This section lists the enumerated types for the Collaboration protocol.

Responses to Connect Requests

These values are passed back to the active side by the passive side in the clbConnectResponse message.

typedef enum
{

clbResponseAcceptNoRedirect = 1,
clbResponseAcceptRedirect,
clbResponseRejectBadConfID,
clbResponseRejectBadConfTime,
clbResponseRejectBadUserID,
clbResponseRejectBadPassword,
clbResponseRejectUnsupportedApp,
clbResponseRejectMaxClients,
clbResponseRejectByUser,
clbResponseRejectOther
} ETClbResponse;

Application Types

The spec calls for a connection request to contain an “application type”.

typedef enum
{

ETAppCollaboration = 1,
ETAppTypeQuickword,
ETAppTypeQuicksheet

} TCLBAPPType;

Types

This section describes the types used by the Collaboration protocol. The structure of the actual messages is listed here. The application will rarely, if ever, deal directly with these structures. Most of that is taken care of by the Collaboration layer.

At the application level the 16-bit and 32-bit integers are in host-byte order.

Collaboration Message Header

This data is at the start of every Collaboration message. These values are set by the Collaboration layer in the clbCreate call. The application should not set these values.

typedef struct
{

UInt32 totalBytes;
UInt32 msgType;
UInt16 ptclVersion;
UInt16 confID;
UInt16 userID;
UInt16 reserved;

} TClbHeader;
typedef TClbHeader TClbMsg;

Collaboration Connect Request Message

This message is sent by active device once the transport connection is up. It contains the header and the password. The password is a NULL-terminated ASCII string.

typedef struct
{

TClbHeader clbHdr;
UInt16 appType;
Char *passWord;

} TClbConnectRequest;

Collaboration Connect Response Message

This message is sent by the passive device after receiving a ConnectRequest message. It validates the password, and sends back a response code and possibly a new address and port for the active side to connect to.

typedef struct
{

TClbHeader clbHdr;
UInt16 responseCode;
Char *redirectAddr;

} TClbConnectResponse;

Collaboration Conference ID Request Message

This message is sent by a soon-to-be passive device to a well-known server to obtain a conference ID. The conference ID value in the header must be set to 0×FFFF. The IP address must be in network-byte order. The password is a NULL terminated ASCII string.

typedef struct
{

TClbHeader clbHdr;
UInt32 IPAddr;
Char *passWord;

} TClbConfIDRequest;

Collaboration Conference ID Response Message

This message is sent by a well-known server to a soon-to-be passive device to give it a new conference ID. The conference ID value in the header must be set to 0×FFFF. The conference ID field in the payload must be in network-byte order.

typedef struct
{

TClbHeader clbHdr;
UInt16 confID;

} TClbConfIDResponse;

Collaboration Set Document Message

The purpose of this message is to indicate that the conference document is being sent. Typically, when a new version of the conference document is available the relay server will send an clbMsgNewDocument message to all clients. The clients will then send the server a clbMsgGetDocument message and the server will reply with a clbMsgSetDocument message with the document.

typedef struct
{

TClbHeader clbHdr;
Char *docName;
// document follows the above

} TClbSetDocMsg;

Collaboration New Document Message

The purpose of this message is to indicate that a new version of the conference document exists. Typically, when a new version of the conference document is available the relay server will send an clbMsgNewDocument message to all clients. The clients will then send the server a clbMsgGetDocument message and the server will reply with a clbMsgSetDocument message with the document.

typedef struct
{

TClbHeader clbHdr;
Char *docName;

} TClbNewDocMsg;

Collaboration Get Document Message

The purpose of this message is to indicate that the sender would like the new version of the conference document sent to it. Typically, when a new version of the conference document is available the relay server will send an clbMsgNewDocument message to all clients. The clients will then send the server a clbMsgGetDocument message and the server will reply with a clbMsgSetDocument message with the document. If the document name is not known by the sender of this message docName can be omitted or the empty string (“”) and the default conference document will be sent back.

typedef struct
{

TClbHeader clbHdr;
Char *docName;

} TClbGetDocMsg;

Collaboration Set Document Ready Message

The purpose of this message is to notify the other peers or relay server that you have opened the conference document. This way, there is no ambiguity of how long it would take to open after it was received. The relay server can know how long to buffer messages until the client is ready.

The client sends the message clbSetDocumentReady and the peer or relay hjandles it. The message expects a DocName.

typedef struct
{

TClbHeader clbHdr;
Char *docName;

} TClbSetDocReadyMsg;

Collaboration Text Message

This is a simple text message, just a Collaboration header, a user ID, and some NULL-terminated text. Set the user ID to 0×FFFF if the text is to be broadcast to all connected users. Otherwise the message will only be sent to the particular user indicated. This field is ignored for peer conferences.

typedef struct
{

TClbHeader clbHdr;
UInt16 userID;
// variable length, NULL-terminated ASCII text will follow

} TClbTextMsg;

Collaboration User Messages

Any user messages (see Message Types section) are free form. The application is expected to call clbCreate to create the message, fill in the payload, and call clbSend to send the message out. The library will ignore the content of those messages and simply send them out or pass them up to the application upon receipt.

Events

These constants define the events that the Collaboration protocol can send back to the application. The application must have an event handler for these events.

The data associated with the events will be contained in the “generic” portion of the event being passed up. The “generic” portion of the event is an array of Int16's. For some events these will be overloaded to contain an address. For each message the associated data passed with the message is given in the comments.

CLB_EVT_XXX_BASE

These values are simply base values to which will be added a value to identify a unique event identifier. System events are 0-999, conference events are 1000-1999, user events are 2000-2999.

| | |
|---|---|
| #define CLB_EVT_SYS_BASE | 0 |
| #define CLB_EVT_CONF_BASE | 1000 |
| #define CLB_EVT_USER_BASE | 2000 |

CLB_CONNECTION_UP

This event is sent to the application as a result of a clbConnect or clbListen call.

Associated Data:

event.evtData16 error code

#define CLB_CONNECTION_UP (CLB_EVT_SYS_BASE+1) // 1

CLB_CONNECTION_DOWN

This event is sent to the application as a result of a clbDisconnect call or if the other side ends the transport connection.

Associated Data:

event.evtData16 error code

#define CLB_CONNECTION_DOWN (CLB_EVT_SYS_BASE+2) // 2

CLB_WRITEMSG_COMPLETE

This event is sent to the application as a result of a clbWrite call. It indicates that all the data has been written to the transport.

Associated Data:

event.evtData16 error code

The library will free the memory used by the outgoing message.

#define CLB_WRITEMSG_COMPLETE (CLB_EVT_SYS_BASE+3) // 3

CLB_WRITEDOC_COMPLETE

Sent to application as a result of a clbSendDocument call. Indicates that the entire document has been sent.

Associated Data:

event.evtData16 error code

#define CLB_WRITEDOC_COMPLETE (CLB_EVT_SYS_BASE+4) // 4

CLB_DATA_RCVD

This event is sent to the application when an entire Collaboration message has been received. The Collaboration layer takes care of reassembly of message fragments that come up from the transport layer.

| | |
|---|---|
| Associated Data: | |
| event.evtData16 | error code |
| event.evtData32 | pointer to TClbMsg. Everything can be |
| | determined from |
| the header. | |
| | Note: it is the application's responsibility to free the |

memory pointed to by evtData32.
#define CLB_DATA_RCVD (CLB_EVT_SYS_BASE+5) // 5

To get access to the memory the pointer represents do something like this:

TClbMsg *clbMsg;
Char *textptr;
// cast it
clbMsg = (TClbMsg *)pEvent->evtData32;
switch( clbMsg->msgType )
{
case clbMsgConfText:

textPtr = (Char *)CLB_BUF_ADDR(clbMsg) ;
textPtr += sizeof ( UInt16 ); // skip around dest user id
FrmCustomAlert ( InfoAlert, textPtr, NULL, NULL );

Note: this example is showing how to access the data in the Collaboration Text Message message.

CLB_NEWDOC_ARRIVED

Sent to application when a new conference document has arrived. The Collaboration layer takes care of writing the document itself to the storage heap. The app should just get the name of the document from this message and read it.

Associated Data:

event.evtData16 error code

event.evtData32 pointer to name of document.

#define CLB_NEWDOC_ARRIVED (CLB_EVT_SYS_BASE+6) // 6

Note: Do not free the pointer in evtData32. It is a static member of the ct1Block structure.

CLB_NEWDOC_EXISTS

Sent to application when someone has announced that there is a new version of the conference document ready to be retrieved. The application should respond by sending out a clbGetDocument message. There is no document attached to this message; it is simply a way to let all the participants know they should go retrieve it.

The app should free the memory pointed to by evtData32.

Associated Data:

```
  event.evtData16 error code
  event.evtData32 pointer to name of document.
#define CLB_NEWDOC_EXISTS (CLB_EVT_SYS_{—}
BASE+7) // 7
```

CLB_REQUEST_NEWDOC

Sent to application when someone has requested the latest version of the conference document, probably as a result of a clbMsgNewDocument message being sent out. The stack sends this message up to the app when a clbSysGetDocument message arrives. There is no document attached to this message.

The app should free the memory pointed to by evtData32.

Associated Data:

```
  event.evtData16 error code
  event.evtData32 pointer to name of document.
#define CLB_REQUEST_NEWDOC (CLB_EVT_SYS_{—}
BASE+8) // 8
```

CLB_BATON_STATUS

Sent to application in response to the application requesting the baton when either:

the other device has responded with a clbMsgBaton message either granting or denying the baton, or

the timeout has expired

the baton has been relinquished

Associated Data:

event.evtData16 baton status, either CLB_BATON_GRANTED,
CLB_BATON_GRANTED_DUE_TO_TIMEOUT, or CLB_{—}
BATON_DENIED,
CLB_BATON_LOST
#define CLB_BATON_STATUS (CLB_EVT SYS_{—}
BASE+9) // 9

CLB_NEWDOC_READY

Sent to application when the document is opened. Result of clbSetDocumentReadyMsg from peer or relay.

The app should free the memory pointed to by evtData32.

Associated Data:

```
  event.evtData16 error code
  event.evtData32 pointer to name of document.
#define CLB_NEWDOC_READY (CLB_EVT_SYS_{—}
BASE+10) // 10
```

CLB_CONFID

Sent to application when a clbSysConfIDResponse message has been received (in response to the clbGetConfID call) with a new conference ID.

Associated Data:

```
  event.evtData16 error code
  event.evtData32 New conference ID. This will be a 16-bit value in a
  32 bit
variable.
#define CLB_CONFID (CLB_EVT_SYS_BASE+6) // 10
```

Application's Main Event Loop

There are three changes that must be made to the application's main event loop where EvtGetEvent is called and processed. A sample event loop is at the end of this section.

clbRun

This function performs three functions:

checks if there are any pending outgoing messages waiting to be sent and, if so, sends them.

checks for any user events to be handled by either the Collaboration layer or the application. If there are any events on the queue it picks the first one off and calls clbHandleEvent to see if it can handle it. If not it calls the callback function registered with the clbRegisterEventCB call to see if the application can handle it. One of these two function must know about and handle any events pulled off the user event queue.

Calls srRun to give the transport layer CPU time. In order to maintain responsiveness to user input the calls to some transport functions are made in non-blocking mode. That means certain functions are called and if there is nothing to do they simple return. For example, listening on a TCP port is usually a blocking call. The NetLib implementation of the sockets “accept” call takes a timeout as a parameter and so must be called in polling fashion. Therefore, there must be some way for this function to be called in a loop. The srRun function performs this function. clbRun must be called in the application's main event loop.

Timeout to EvtGetEvent()

In order to implement the desired responsiveness at both the application layer and the communications layer a small timeout should be passed into EvtGetEvent in the application's main event loop. See the following example.

Example Main Event Loop

void AppEventLoop (void)
{

EventType event;
do
{

// allow the Collab layer to run
clbRun( &gCtlBlock );
// don't pass evtWaitForever into EvtGetEvent
// EvtGetEvent (&event, evtWaitForever);
EvtGetEvent (&event, 10);
// Ask system to handle event.
if (false == SysHandleEvent (&event))
{

// System did not handle event.
Word error;
// Ask Menu to handle event.
if (false == MenuHandleEvent (0, &event, &error))
{

// Menu did not handle event.
// Ask App (that is, this) to handle event.
if (false == AppEventHandler (&event))
{

// App did not handle event.
// Send event to appropriate form.
FrmDispatchEvent (&event);
} // end if (false == AppEventHandler (&event))
} // end if (false == MenuHandleEvent
(0, &event, &error))
} // end if (false == SysHandleEvent (&event))
}

while (event.eType != appStopEvent);

}

Notifying the stack which function will handle events

The application must register a callback function with the stack in order to receive events back from the stack. The prototype for this callback function must be:

Boolean CBFunc( QEventType *evt, void *ptr );

Use the clbRegisterEventCB API call to register the callback function. A good place to do this might be in the initialize function for the active form.

ErrorAlert Resource

Both the Collaboration layer and the communications layer make use of an alert resource with an id of 1000. This resource is set in Alert.h. Change the value to an alert resource that takes one parameter (“\hat{ }”).

Closing the Log File

A call to LOGCLOSE must be made at the end of the application's AppStop() function to close the log file. If logging is not enabled the LOGCLOSE macro resolves to nothing. If logging is enabled LOGCLOSE resolves to LogClose() so no parentheses are needed. There is no need to open the log; it is opened the first time a logging call is made. Handling Collaboration Messages to the Application

The Collaboration layer will pass up the following events to the application:

CLB_CONNECTION_UP

CLB_CONNECTION_DOWN

CLB_WRITEMSG_COMPLETE

CLB_WRITEDOC_COMPLETE

CLB_DATA_RCVD

CLB_NEWDOC_ARRIVED

CLB_NEWDOC_EXISTS

CLB_REQUEST_NEWDOC

CLB_BATON_STATUS

CLB_CONFID

The application must handle these events in the function passed in via the clbRegisterEventCB API call. Here is a sample function. (Note: this does not have any actual code to handle the events; it is merely to illustrate the structure)

Boolean MainFormHandleClbEvents( QEventType *pEvent, void *ptr )
{

Boolean handled = false;
TSRCtlBlock *ctlBlock = (TSRCtlBlock *)ptr;
switch( pEvent->evtType )
{

case CLB_CONNECTION_UP:

handled = true;

break;
case CLB_CONNECTION_DOWN:

handled = true;

break;
case CLB_WRITEMSG_COMPLETE:

handled = true;

break;
case CLB_WRITEDOC_COMPLETE:

handled = true;

break;
case CLB_DATA_RCVD:

handled = true;

break;
case CLB_NEWDOC_ARRIVED:

handled = true;

break;
case CLB_NEWDOC_EXISTS:

handled = true;

break;
case CLB_REQUEST_NEWDOC:

handled = true;

break;
case CLB_BATON_STATUS:

handled = true;

break;
case CLB_CONFID:

handled = true;

break;
default:

handled = false;

break;
} // end switch
return handled;

}

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A wireless collaboration software program executable on a PDA readable medium, comprising:
a conferencing and collaboration protocol (CCP) enabled to wirelessly communicate with another said wireless collaboration software program resident on a physically remote communication device in near real time.

2. The wireless collaboration software program as specified in claim 1 wherein the CCP is enabled to wirelessly collaborate data of an application running on the PDA with a common application running on the physically remote device without substantial changes to the PDA application.

3. The wireless collaboration software program as specified in claim 2 wherein the CCP is enabled to update the PDA internal state to mirror that of the physically remote communication device.

4. The wireless collaboration software program as specified in claim 3 wherein the CCP is enabled to collaborate data and screen information.

5. The wireless collaboration software program as specified in claim 4 wherein the CCP is enabled such that received screen information can be selectively filtered while processing received data information.

6. The wireless collaboration software program as specified in claim 1 further comprising an application program interface (API) implemented by the CCP.

7. The wireless collaboration software program as specified in claim 6 wherein the CCP is enabled to communicate asynchronously exchange data with the remote communication device.

8. The wireless collaboration software program as specified in claim 6 further comprising a CCP system library implemented by the API.

9. The wireless collaboration software program as specified in claim 8 wherein the CCP system library is adapted to handle conference messages of the CCP communicated to and from the remote communication device.

10. The wireless collaboration software program as specified in claim 9 wherein the conference messages comprise conference protocol messages, system update messages, system edit messages, and system update messages.

11. The wireless collaboration software program as specified in claim 10 wherein the conference messages are a structured set of bytes.

12. The wireless collaboration software program as specified in claim 8 further comprising a CCP event handler processing specific events produced by the CCP system library.

13. The wireless collaboration software program as specified in claim 12 further comprising a plurality of function blocks, wherein the CCP event handler is also adapted to handle specific events to existing and new said function blocks.

14. The wireless collaboration software program as specified in claim 1 wherein the wireless collaboration software program is enabled to automatically send a document to another said wireless collaboration software program upon communication therewith, the document being editable by both the PDA and the physically remote communication device.

15. The wireless collaboration software program as specified in claim 1 wherein the application is an off-the-shelf application.

16. The wireless collaboration software program as specified in claim 1 wherein the remote communication device is another PDA.

17. The wireless collaboration software program as specified in claim 1 wherein the remote communication device is a desktop computer.

18. The wireless collaboration software program as specified in claim 1 wherein the remote communication device is a livefeed gateway.

19. A PDA enabled to wirelessly collaborate with a remote communication device in near real-time, comprising:
memory, a CPU, and a PDA operating system; and
a wireless collaboration software program loaded on and executable by the PDA, comprising:
a conferencing and collaboration protocol (CCP) enabled to wirelessly communicate with another said wireless collaboration software program resident on a physically remote communication device in near real time.

20. The wireless collaboration software program as specified in claim 19 wherein the CCP is enabled to wirelessly collaborate data of an application running on the PDA with a common application running on the physically remote device without substantial changes to the PDA application.

21. The wireless collaboration software program as specified in claim 19 wherein the CCP is enabled to update the PDA internal state to mirror that of the physically remote communication device.

22. The wireless collaboration software program as specified in claim 20 wherein the CCP is enabled to collaborate data and screen information.

23. The wireless collaboration software program as specified in claim 21 wherein the CCP is enabled such that received screen information can be selectively filtered while processing received data information.

24. The wireless collaboration software program as specified in claim 19 further comprising an application program interface (API) implemented by the CCP.

25. The wireless collaboration software program as specified in claim 19 wherein the CCP is enabled to communicate asynchronously exchange data with the remote communication device.

26. The wireless collaboration software program as specified in claim 24 further comprising a CCP system library implemented by the API.

27. The wireless collaboration software program as specified in claim 26 wherein the CCP system library is adapted to handle conference messages of the CCP communicated to and from the remote communication device.

28. The wireless collaboration software program as specified in claim 27 wherein the conference message comprise conference protocol messages, system update messages, system edit messages, and system update messages.

29. The wireless collaboration software program as specified in claim 27 wherein the conference messages are a structured set of bytes.

30. The wireless collaboration software program as specified in claim 26 further comprising a CCP event handler processing specific events produced by the CCP system library.

31. The wireless collaboration software program as specified in claim 30 further comprising a plurality of function blocks, wherein the CCP event handler is also adapted to handle specific events to existing and new said function blocks.

32. The wireless collaboration software program as specified in claim 19 wherein the CCP is enabled to automatically send a document to another said wireless collaboration software program residing on the remote communication device upon communication therewith.

33. The wireless collaboration software program as specified in claim 19 wherein the application is an off-the-shelf application.

34. The PDA as specified in claim 19, wherein the wireless collaboration software program is enabled to collaborate with another remote PDA device in near real-time.

35. The PDA as specified in claim 19, wherein the wireless collaboration software program is enabled to collaborate with a desktop computer in near real-time.

36. The PDA as specified in claim 19, wherein the wireless collaboration software program is enabled to collaborate with a livefeed gateway in near real-time.

37. A method of wirelessly collaborating between a PDA and a physically remote communication device in near real-time, comprising:
the PDA executing a first resident program and collaborating with the physically remote communication device also executing the first resident program to wirelessly collaborate therewith in near realtime.

38. The method as specified in claim 37 wherein each the PDA and the physically remote communication device are running a common application, wherein said wireless collaboration is performed without substantial changes to the application of either the PDA or the physically remote communication device.

39. The method as specified in claim 37 wherein the PDA includes a wireless collaboration software program executable on the PDA, comprising:
a conferencing and collaboration protocol (CCP) enabled to communicate with another said wireless collaboration software program resident on a remote communication device in near real time.

40. The method as specified in claim 39 wherein the collaboration software program is also resident on and executable by the remote communication device.

41. The method as specified in claim 37 wherein the PDA is enabled to update its internal state to mirror that of the physically remote communication device.

42. The method as specified in claim 38 wherein the PDA is enabled to collaborate data and screen information.

43. The method as specified in claim 39 wherein the PDA is enabled such that received screen information can be selectively filtered while processing received data information.

44. The method as specified in claim 39 wherein the wireless collaboration software program also comprises an application program interface (API) implemented by the CCP.

45. The wireless collaboration software program as specified in claim 35 wherein the CCP is enabled to communicate asynchronously exchange data with the remote communication device.

46. The wireless collaboration software program as specified in claim 39 wherein the collaboration software program further comprises a CCP system library implemented by the API.

47. The wireless collaboration software program as specified in claim 46 wherein the CCP system library is adapted to handle conference messages of the CCP communicated to and from the remote communication device.

48. The wireless collaboration software program as specified in claim 47 wherein the conference message comprise conference protocol messages, system update messages, system edit messages, and system update messages.

49. The wireless collaboration software program as specified in claim 48 wherein the conference messages are a structured set of bytes.

50. The wireless collaboration software program as specified in claim 39 wherein the collaboration software program further comprising a CCP event handler processing specific events produced by the CCP system library.

51. The wireless collaboration software program as specified in claim 39 wherein the collaboration software program further comprises a plurality of function blocks, wherein the CCP event handler is also adapted to make calls to existing and new said function blocks.

52. The method as specified in claim 37 further comprising the step of the PDA being designated a host and automatically sending a first document to the physically remote communication device to begin the wireless collaboration.

53. The method as specified in claim 37 further comprising the step of the physically remote communication device being designated a host and automatically sending the first document to the PDA to begin the wireless collaboration.

54. The method as specified in claim 37 wherein the common application is an off-the-shelf application.

55. The method as specified in claim 37 wherein the remote communication device is another PDA.

56. The method as specified in claim 37 wherein the remote communication device is a desktop computer.

57. The method as specified in claim 37 wherein the remote communication device is a livefeed gateway.

58. The method as specified in claim 52 wherein the first document is editable by both the PDA and the physically remote communication device.

59. The method as specified in claim 53 wherein the first document is editable by both the PDA and the physically remote communication device.

60. The method as specified in claim 37 further comprising the step of the PDA simultaneously exchanging voice communication with the physically remote communication device during the collaboration.
